(19) United States
(12) Patent Application Publication
(10) Pub. No.: US 2026/0188994 A1
(43) Pub. Date: Jul. 2, 2026

(54) CIRCUIT BREAKER DEVICE AND METHOD

(71) Applicant: Siemens Aktiengesellschaft, München (DE)

(72) Inventor: Marvin Tannhäuser, Hausen (DE)

(21) Appl. No.: 19/127,188

(22) PCT Filed: Oct. 11, 2023
(86) PCT No.: PCT/EP2023/078230

§ 371 Date: May 5, 2025

(30) Foreign Application Priority Data
Nov. 4, 2022 (DE) 10 2022 211 677.1

(51) Int. Cl. H02H 3/02; H01H 9/54; H01H 9/56; H02H 3/06; H02H 3/08; H02H 3/093

(52) U.S. Cl. CPC H02H 3/021; H01H 9/548; H01H 9/563; H02H 3/06; H02H 3/083; H02H 3/093

(57) ABSTRACT

A circuit breaker protects an electrical three-phase low-voltage AC circuit having a neutral conductor. The breaker contains series circuits composed of a mechanical phase contact and an electronic switch. Each series circuit electrically connects a grid-side phase connection to a load-side phase connection. A grid-side neutral conductor connection is connected to a load-side neutral conductor connection via a mechanical neutral conductor contact. The mechanical contacts can be opened together to prevent a flow of current or closed together to enable a flow of current. The electronic switches are switched, by the semiconductor-based switching elements, to a high-impedance state to prevent a flow of current or to a low-impedance state to enable the flow of current. The electronic switches are switched to a high-impedance or a low-impedance state independently of one another to prevent a flow of current which is dependent on the phase conductor or to enable same.

The invention relates to the technical field of a circuit breaker for a low-voltage circuit having electronic switches and a method for a circuit breaker for a low-voltage circuit having electronic switches.

Low voltage means voltages of up to 1000 volts AC voltage or up to 1500 volts DC voltage. Low voltage in particular means voltages which are greater than the small voltage, with values of 50 volts AC voltage or 120 volts DC voltage.

Low-voltage circuit or grid or system means circuits with nominal currents or rated currents of up to 125 amperes, more specifically up to 63 amperes. Low-voltage circuit in particular means circuits with nominal currents or rated currents of up to 50 amperes, 40 amperes, 32 amperes, 25 amperes, 16 amperes or 10 amperes. The current values mentioned in particular mean nominal, rated or/and interrupting currents, i.e. the current which is normally carried at maximum across the circuit or at which the electrical circuit is usually interrupted, for example by means of a protective device, such as a circuit breaker, miniature circuit breaker or power circuit breaker. The nominal currents can further be graded from 0.5 A via 1 A, 2 A, 3 A, 4 A, 5 A, 6 A, 7 A, 8 A, 9 A, 10 A, etc. up to 16 A.

Miniature circuit breakers are overcurrent protective devices that have been known for a long time, which are used in low-voltage circuits in electrical installation technol-ogy. These protect lines from damage due to heating as a consequence of excessive current and/or short circuit. A miniature circuit breaker can automatically interrupt the circuit in the case of overload and/or short circuit. A miniature circuit breaker is a safety element that does not reset automatically.

Power circuit breakers are, in contrast to miniature circuit breakers, provided for currents greater than 125 A, in some cases also even from 63 amperes. Miniature circuit breakers are therefore of simpler and more delicate design. Miniature circuit breakers usually have a fastening option for fastening to what is known as a top-hat rail (mounting rail, DIN rail, TH35).

Miniature circuit breakers are electromechanically con-structed. In a housing, they have a mechanical switching contact or shunt release for interrupting (tripping) the electric current. Usually, a bimetal protective element or bimetal element is used for tripping (interruption) in the case of longer-lasting overcurrent (overcurrent protection) or in the case of thermal overload (overload protection). An electromagnetic tripping device having a coil is used for short-term tripping when an overcurrent limit value is exceeded or in the event of a short circuit (short circuit protection). One or more arc quenching chamber(s) or devices for arc quenching are provided. Further, connector elements for conductors of the electrical circuit to be protected.

Circuit breakers having an electronic interrupt unit or an electronic switch are relatively novel developments. These have a semiconductor-based electronic interrupt unit/switch. That is to say, the electric current flow of the low-voltage circuit is carried via semiconductor components or semiconductor switches which can interrupt the electric current flow or be turned on. Circuit breakers having an electronic interrupt unit/switch further fre-quently have a mechanical break contact unit, particularly with disconnector features according to relevant standards for low-voltage circuits, wherein the contacts of the mechanical break contact unit are connected in series to the electronic interrupt unit/electronic switches, i.e. the current of the low-voltage circuit that is to be protected is carried both via the mechanical break contact unit and via the electronic interrupt unit.

The present invention relates in particular to low-voltage AC circuits, having an AC voltage, usually having a time-dependent sinusoidal AC voltage with the frequency f. The time dependence of the instantaneous voltage value u(t) of the AC voltage is described by the equation:

$$u ( t ) = U ⋆ sin ( 2 π ⋆ f ⋆ t ) .$$

$$Where$$

$$u ( t ) = instantaneous voltage value at time t$$

$$U = amplitude of the voltage$$

A harmonic AC voltage can be shown by the rotation of a pointer, the length of which corresponds to the amplitude (U) of the voltage. The instantaneous deflection is in this case the projection of the pointer onto a coordinate system. A period of oscillation corresponds to a full rotation of the pointer and the full angle thereof is 2π (2 pi) or 360°. The angular frequency is the rate of change of the phase angle of this rotating pointer. The angular frequency of a harmonic oscillation is always 2π-times its frequency, i.e.:

$$ω = 2 π * f = 2 π / T = angular frequency of the AC voltage$$

$$( T = period of the oscillation )$$

The specification of the angular frequency (ω) with respect to the frequency (f) is often preferred, as many formulae of the theory of oscillation can be represented in a more compact manner with the aid of the angular frequency owing to the occurrence of trigonometric functions, the period of which per definition is 2π:

$$u ( t ) = U ⋆ sin ( ω t )$$

The term instantaneous angular frequency is also used in the event of angular frequencies that are not constant over time.

In the case of a sinusoidal AC voltage, which is constant over time in particular, the time-dependent value from the angular speed φ and the time t corresponds to the time-dependent angle q (t) which is also termed the phase angle φ (t). That is to say, the phase angle φ (t) periodically runs through the range 0 . . . 2π or 0° . . . 360°. That is to say, the phase angle periodically assumes a value between 0 and 2π or 0° and 360° (p=n*(0 . . . 2π) or (=n*(0° . . . ) 360° owing to periodicity; in short: (=0 . . . 2π or (=0° . . . ) 360°.

The instantaneous voltage value u(t) consequently means the instantaneous value of the voltage at time t, i.e. in the case of a sinusoidal (periodic) AC voltage, the value of the voltage at phase angle φ (φ=0 . . . 2π or φ=0° . . . 360° of the respective period). The same is true with respect to instantaneous current values i(t), etc.

The object of the present invention is to improve a circuit breaker of the type mentioned in the introduction, particularly to indicate a novel concept for a multi-phase circuit breaker and also to enable a higher flexibility for a multi-phase circuit breaker.

This object is achieved by a circuit breaker having the features of patent claim 1 and by a method as claimed in patent claim 17.

According to the invention, a circuit breaker for protecting an electrical multi-phase low-voltage AC circuit with neutral conductors, particularly three-phase low-voltage AC circuit with neutral conductors, is proposed, having:
a housing having a first, second and third grid-side phase connection and a first, second and third load-side phase connection for a first, second and third phase conductor of the three-phase low-voltage AC circuit, a grid-side neutral conductor connection and a load-side neutral conductor connection for a neutral conductor of the low-voltage AC circuit,
a first series connection of a first mechanical phase contact and a first electronic switch, a second series connection of a second mechanical phase contact and a second electronic switch, a third series connection of a third mechanical phase contact and a third electronic switch, wherein the first series connection electrically connects the first grid-side phase connection to the first load-side phase connection, the second series connection electrically connects the second grid-side phase connection to the second load-side phase connection and the third series connection electrically connects the third grid-side phase connection to the third load-side phase connection,
in that the grid-side neutral conductor connection is connected to the load-side neutral conductor connection via a mechanical neutral conductor contact,
in that the mechanical phase contacts and the mechanical neutral conductor contact can be switched to open together for avoiding a current flow or can be switched to close together for a current flow,
in that the electronic switches can be switched by means of semiconductor-based switching elements into a high-resistance state of the switching elements for avoiding a current flow or a low-resistance state of the switching elements for the current flow,
in that the circuit breaker is configured in such a manner that the first, second and third electronic switches can be switched independently of one another to a high-resistance or low-resistance state.

This has the advantage that the phase conductors can be switched into the high-resistance or low-resistance state independently of one another. Previous circuit breakers, particularly the widely used classic electromechanical circuit breakers (miniature circuit breakers, power circuit breakers, residual-current-operated circuit breakers) do not have this option, as the mechanical break contact unit there opens or closes all contacts simultaneously (multi-pole devices).

Thus, a higher flexibility of a circuit breaker and a more flexible switching performance are enabled.

Further advantageous embodiments of the invention are spec-ified in the subordinate claims and in the exemplary embodiment.

In an advantageous embodiment of the invention, a current sensor unit is provided in each case for each series connection for respectively determining the level of the cur-rent of the respective phase conductor. In particular that instantaneous current values are (determined and) known. That is to say that a first, second and third current sensor unit are provided. That the first current sensor unit is provided in the first series connection, the second cur-rent sensor unit is provided in the second series connection and the third current sensor unit is provided in the third series connection for respectively determining the level of the current of the first, second and third phase conductors, particularly in such a manner that instantaneous current values are known.

In an advantageous development of the same, a control unit is provided, which is connected to the current sensor units, the mechanical contacts and the electronic switches. The circuit breaker is configured in such a manner that when at least one first current threshold value is exceeded in a phase conductor, avoidance of a current flow of the relevant phase conductor is initiated, particularly for a first time span, by the relevant electronic switch.

This has the particular advantage that when a fixed current threshold or a current/time threshold value is exceeded (i.e. the current threshold value is exceeded for a defined time period), a selective interruption of only the affected conductor (or the relevant conductor) takes place. In the other conductors (non-affected conductors) in a multi-phase low-voltage AC circuit, a current flow is furthermore enabled.

Due to the avoidance for a first time span, reclosing or becoming low-resistance advantageously takes place after the first time span, so that security of supply is further ensured or it is further possible to check for the existence of the exceedance of the current threshold. Particularly due to the evaluation of instantaneous values of the level of the current, it is possible to carry this out in an advantageous manner.

In an advantageous embodiment of the invention, the first time span is less than 20 ms, particularly less than 10 ms.

This has the particular advantage that for a half wave or full wave of the voltage or the current in the AC circuit, in the example (20 ms, 10 ms) with respect to a power frequency of 50 Hz, an interruption takes place, so security of electrical supply is restored with the next full or half wave. In particular, following an interruption, becoming low-resistance can take place in the region of the next zero crossing (at the zero crossing or in the region of 1 ms before or after that).

In an advantageous embodiment of the invention, the circuit breaker is configured in such a manner that when at least one second current threshold value, particularly an effec-tive value, is exceeded in at least one phase conductor (or two phase conductors, particularly in three phase conductors) for at least a first time period, avoidance of a cur-rent flow is initiated by opening the contacts.

The second current threshold value can advantageously be higher than the first current threshold value in terms of magnitude.

The first time period can be less than 100 ms, 20 ms, in particular less than 10 ms.

3 This has the particular advantage that if one of the electronic switches or the electronic switch defectively re-mains at low resistance and following that, the second cur-rent threshold value is exceeded, avoidance of the current flow in the low-voltage AC circuit is initiated and thus the security in the circuit is increased.

In an advantageous embodiment of the invention, the mechanical neutral conductor contact can be opened or closed together with the phase contacts. In particular, prior to the closing of the phase contacts, the neutral conductor contact is closed or (/and), following the opening of the phase contacts, the neutral conductor contact is opened.

This has the particular advantage that the neutral conductor contact always opens and closes in a de-energized state. This reduces the wear of the contact and increases the service life. Furthermore, the occurrence of an electric arc when the neutral conductor contact opens is avoided as a result of this.

In an advantageous embodiment of the invention, the mechanical phase contacts are part of a mechanical break contact unit which opens or closes the contacts together. In particular, the mechanical break contact unit has a handle that is accessible on the circuit breaker for manual (user-activated) opening or closing of the phase contacts (of the mechanical break contact unit).

This has the particular advantage that a complete electrical isolation of all phase conductors is performed simultaneously, in contrast to the electronic switch becoming high resistance in a phase-related manner that avoids current flow. The handle enables compatible behavior in accordance with classic electromechanical circuit breakers.

In an advantageous embodiment of the invention, the circuit breaker is configured in such a manner that the mechanical break contact unit can be opened by the control unit, but not closed. In particular, closing of the mechanical break contact unit by means of the handle is only possible after release by means of the control unit.

This has the particular advantage that there is increased safety of the circuit breaker, as the control unit cannot inadvertently (erroneously) close the contacts.

In an advantageous embodiment of the invention, the electronic switches are part of an electronic interrupt unit, wherein the electronic switches are switchable independently of one another.

This has the particular advantage that it results in a compact electronic interrupt unit which integrates the electronic switches so that a space-saving design is enabled and it is possible to use synergistic effects of components.

In an advantageous embodiment of the invention, the electronic interrupt unit/the electronic switches has/have a bidirectional dielectric strength. In particular, a surge protector is provided for the semiconductor-based switching elements.

This has the particular advantage that there is robustness with respect to overvoltages and it is possible to switch off an inductive line circuit.

In an advantageous embodiment of the invention, the mechanical phase contacts are assigned to the load-side phase connections and the electronic switches are assigned to the grid-side phase connections.

This has the particular advantage that there is an advantageous design which assists a phase-related switching of the electronic switches and also enables a self-test (particularly a self-test of the electronic switches and the electronic interrupt unit), even if the contacts are open. Furthermore, a supply of power to the circuit breaker is ensured even if the contacts are open.

In an advantageous embodiment of the invention, a voltage sensor unit is provided in each case between each phase conductor and the neutral conductor for determining the level of the voltage between the respective phase conductor and neutral conductor, particularly that instantaneous voltage values are known. The voltage sensor units are connected to the control unit.

In an advantageous development of the embodiment, the circuit breaker is configured in such a manner that when the control unit initiates the (all of the) electronic switches becoming low-resistance (particularly if there is no over-current event, i.e. if the first or second current thresh-old value is not exceeded; e.g. if becoming low-resistance is initiated by a user), these become low-resistance suc-cessively at the respective zero crossing of the voltage (or at a voltage that is less than 50V, 25V, in particular is less than 10V).

This has the particular advantage that the switch-off load (and thus also the wear) in the electronic switch is re-duced. Furthermore, the system perturbations are reduced as a result of this.

In an advantageous embodiment of the invention, the circuit breaker is configured in such a manner that when the con-trol unit initiates the (all of the) electronic switches becoming high-resistance (particularly if there is no over-current event, i.e. if the first or second current thresh-old value is not exceeded; e.g. if becoming high-resistance is initiated by a user), these become high-resistance suc-cessively at the respective zero crossing of the voltage (or at a voltage that is less than 50V, 25V, in particular is less than 10V).

This has the particular advantage that system perturbations are reduced and the switch-off load in the switch is lower.

In an advantageous embodiment of the invention, a/the con-trol unit is provided, which is connected to the current sensor units, the voltage sensor units, the mechanical phase contacts and the electronic switches. The circuit breaker is configured in such a manner that when (at least) the first current threshold value is exceeded in a conductor, avoidance of a current flow of the relevant conductor is initiated by the relevant electronic switch. At the next or next but one zero crossing of the voltage, the electronic switch becomes low-resistance again in order to ena-ble a current flow.

This has the particular advantage that an increased robust-ness is achieved with respect to false trippings and thus an increased security of electrical supply is achieved.

In an advantageous embodiment of the invention for the three-phase low-voltage AC circuit, which advantageously presents a solution for a classic three-phase grid, the circuit breaker has at least the following switching states:
all mechanical phase contacts open, all electronic switches high-resistance,
all mechanical phase contacts closed, all electronic switches low-resistance,
all mechanical phase contacts closed, all electronic switches high-resistance,
all mechanical phase contacts closed, the first electronic switch low-resistance, the second and third electronic switches high-resistance,
all mechanical phase contacts closed, the second electronic switch low-resistance, the first and third electronic switches high-resistance,
all mechanical phase contacts closed, the third electronic switch low-resistance, the first and second electronic switches high-resistance.

In a further advantageous embodiment of the invention for the three-phase low-voltage AC circuit, the circuit breaker has at least the following switching states:
all mechanical phase contacts open, all electronic switches high-resistance,
all mechanical phase contacts closed, all electronic switches low-resistance,
all mechanical phase contacts closed, all electronic switches high-resistance,
all mechanical phase contacts closed, the first and second electronic switches low-resistance, the third electronic switch high-resistance,
all mechanical phase contacts closed, the first and third electronic switches low-resistance, the second electronic switch high-resistance,
all mechanical phase contacts closed, the second and third electronic switches low-resistance, the first electronic switch high-resistance.

The two advantageous embodiments or the combinations of both have the particular advantage that novel switching states of a circuit breaker are provided in order to react individually and more flexibly to overcurrent conditions (short circuit current conditions). Thus, the reaction is not to switch off all phases, rather it is possible to act in a phase-related manner, so that a higher security of supply is enabled in the low-voltage circuit.

In a further advantageous embodiment of the invention, the circuit breaker has at least the following switching state:
all mechanical phase contacts open, a portion of the electronic switches low-resistance, the other portion of the electronic switches high-resistance,
in particular the one electronic switch is low-resistance and the other electronic switches are high-resistance, al-ternatively or additionally in that in particular two electronic switches are low-resistance and the other electronic switch is high-resistance.

Alternatively or additionally, the circuit breaker can have the following switching state:
all mechanical phase contacts open, all electronic switches low-resistance.

In particular, these switching states are provided if a measuring resistance is provided in each case between a phase conductor and the neutral conductor. To this end, in one embodiment a first measuring resistance is provided between the first phase conductor L1 and the neutral conductor N, a second measuring resistance is provided between the second phase conductor L2 and the neutral conductor N, and a third measuring resistance is provided between the third phase conductor L3 and the neutral conductor N.

These switching states are advantageously provided for checking the ability to switch the electronic switches on and off. That is to say, the electronic switches are briefly switched on with open mechanical phase contacts in order to carry out a check of the functionality (with re-gard to ability to switch on or (/and) off). A measuring current flows via the respective measuring resistances here.

According to the invention, a corresponding method (method claims) for a circuit breaker for a low-voltage circuit having electronic (semiconductor-based) switches/switching elements is claimed with the same and further advantages.

The method for a circuit breaker (SG) for protecting an electrical three-phase low-voltage AC circuit with neutral conductors has:
series connections of a mechanical phase contact and an electronic switch,
wherein in each case one series connection electrically connects a grid-side phase connection to a load-side phase connection,
in that a grid-side neutral conductor connection is connected to a load-side neutral conductor connection via a mechanical neutral conductor contact,
in that the mechanical contacts can be opened together for avoiding a current flow or can be closed together for a current flow,
in that the electronic switches can be switched by means of semiconductor-based switching elements into a high-resistance state of the switching elements for avoiding a current flow or a low-resistance state of the switching elements for the current flow,
in that the electronic switches can be switched into a high-resistance or low-resistance state independently of one another, in order (advantageously) to avoid or to ena-ble a phase-conductor-dependent current flow.

Advantageously, the level of the current of the respective series connection is determined and when at least one first current threshold value is exceeded in a series connection, avoidance of a current flow of the relevant series connection is initiated, particularly for a first time span, by the relevant electronic switch.

All embodiments, both in dependent form referring back to patent claim 1 or 17 and also referring back only to indi-vidual features or feature combinations of patent claims, particularly also a back reference of the dependent arrangement claims to the independent method claim, effect an improvement of a circuit breaker, particularly an improvement of the safety of the electrical circuit, and provide a novel concept for a circuit breaker.

The described properties, features and advantages of this invention and the manner in which these are achieved become clearer and more clearly understandable in connection with the following description of the exemplary embodiments that are explained in more detail in connection with the drawing.

In the drawing:

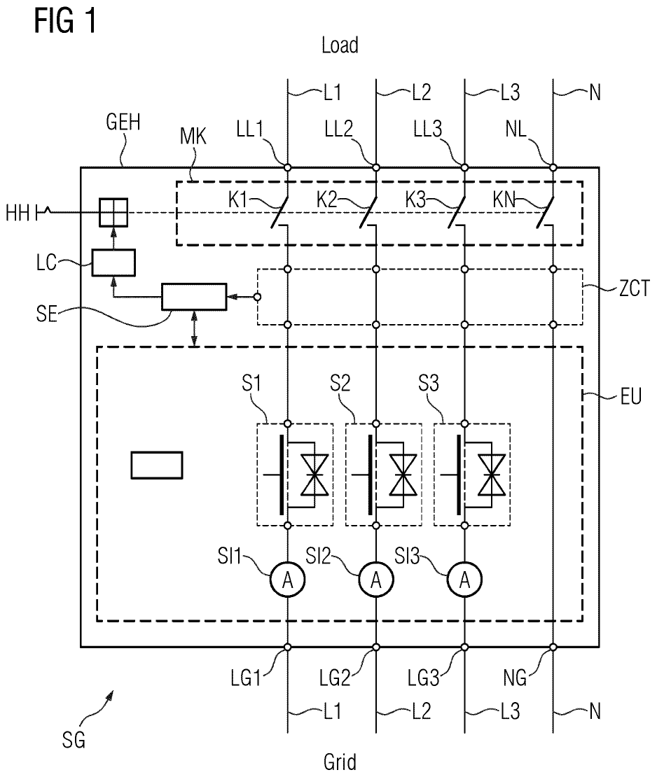

FIG. 1 shows a first illustration of a circuit breaker,

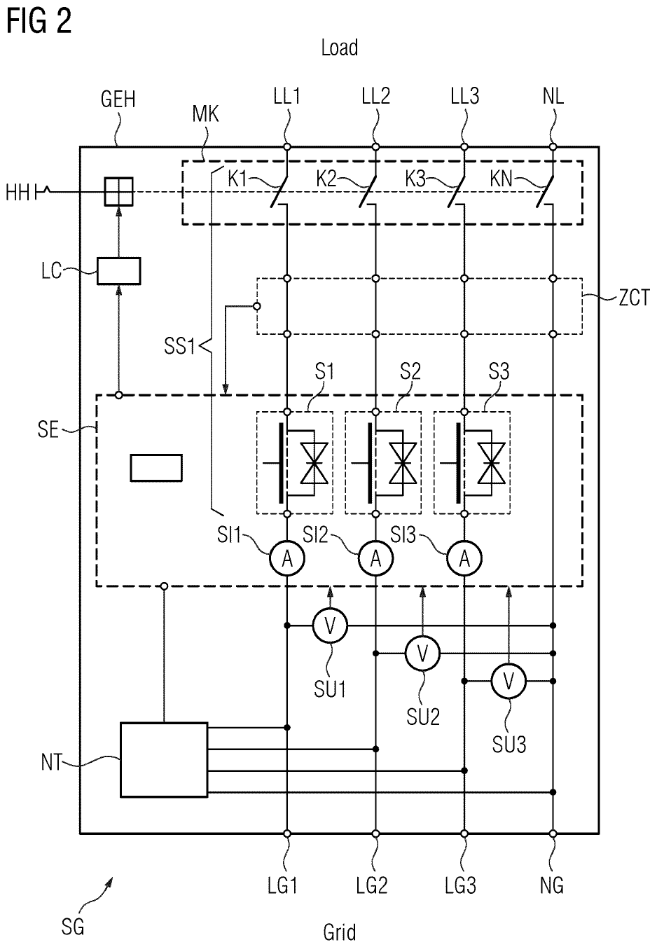

FIG. 2 shows a second illustration of a circuit breaker,

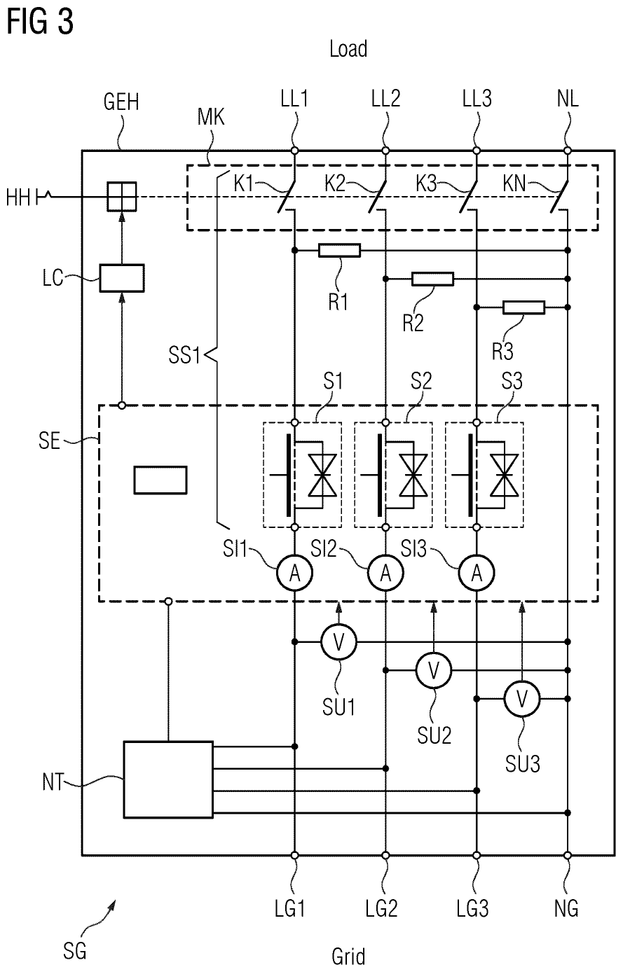

FIG. 3 shows a third illustration of a circuit breaker.

FIG. 1 shows an exemplary illustration of a circuit breaker SG, which is 4-pole in the example, i.e. e.g. for 3-phase conductors and one neutral conductor, for protecting an electrical three-phase low-voltage AC circuit with neutral conductors, having:
a housing GEH having a first, second and third grid-side phase connection LG1, LG2, LG3 and a first, second and third load-side phase connection LL1, LL2, LL3 for the first, second and third phase conductors L1, L2, L3 of the low-voltage AC circuit,
a grid-side neutral conductor connection NG and a load-side neutral conductor connection NL for a neutral conductor N of the low-voltage AC circuit,
a power source is usually connected at the grid side Grid, a consumer is usually connected at the load side Load.

26 In the housing GEH:
a first series connection SS1 of a first mechanical phase contact K1 and a first electronic switch S1,
a second series connection SS2 of a second mechanical phase contact K2 and a second electronic switch S2,
a third series connection SS3 of a third mechanical phase contact K3 and a third electronic switch S3,
wherein (inside the housing):
the first series connection SS1 electrically connects the first grid-side phase connection LG1 to the first load-side phase connection LL1,
the second series connection SS2 electrically connects the second grid-side phase connection LG2 to the second load-side phase connection LL2, and
the third series connection SS3 electrically connects the third grid-side phase connection LG3 to the third load-side phase connection LL3,
the grid-side neutral conductor connection (NG) is connected to the load-side neutral conductor connection (NL) via a mechanical neutral conductor contact (KN),
the mechanical phase contacts K1, K2, K3 and the mechanical neutral conductor contact KN can be switched together, i.e. are opened together for avoiding a current flow or are closed together for a current flow, i.e. the mechanical contacts are connected to one another via a mechanical cou-pling (e.g. breaker shaft),
the electronic switches S1, S2, S3 can be switched by means of semiconductor-based switching elements into a high-resistance state of the switching elements for avoiding a current flow or a low-resistance state of the switching elements for the current flow.

According to the invention, the circuit breaker is configured in such a manner that the first, second and third electronic switches can be switched independently of one another to a high-resistance or low-resistance state. That is to say, the first, second and third electronic switches are switched independently of one another to a high-resistance or low-resistance state. Particularly in order to avoid or to enable a phase-conductor-dependent current flow.

According to FIG. 1, a first, second and third current sensor unit SI1, SI2, SI3 are provided. The first current sensor unit SI1 is provided or arranged in the first series connection SS1, the second current sensor unit SI2 is provided or arranged in the second series connection SS2 and the third current sensor unit SI3 is provided or arranged in the third series connection SS3 for respectively determining the level of the current of the first, second and third phase conductors, particularly that instantaneous current values are known.

The first mechanical phase contact K1, the second mechanical phase contact K2 and the third mechanical phase contact K3 and also the mechanical neutral conductor contact KN are, according to FIG. 1, part of a mechanical break contact unit MK which opens or closes the phase contacts K1, K2, K3 and the neutral conductor contact KN together. The mechanical break contact unit MK can have a handle HH that is accessible on the circuit breaker for manual (activated by a person) opening or closing of the contacts. The mechanical break contact unit MK corresponds for example to a classic unit, as is known from electromechanical circuit breakers (miniature circuit breakers, power circuit breakers) (but according to the invention without elements for overcurrent or short circuit detection, such as bimetallic tripping devices, etc.).

The circuit breaker is in particular configured in such a manner that the mechanical break contact unit MK can be opened, but not closed by a control unit SE. In particular, closing of the mechanical break contact unit MK by means of the handle HH is only possible after release by means of the control unit SE. A release unit LC can be provided for this. That is to say, the contacts can only be closed by means of the handle HH if the release or a release signal (from the control unit) exists. Without the release or the release signal, although the handle HH can be actuated, the contacts cannot be closed (“permanent slider contacts”).

The release unit LC can further be configured in such a manner that opening of the contacts K1, K2, K3, KN of the mechanical break contact unit MK is possible by means of a control signal of the control unit SE, as indicated in fig-ure 1 by an arrow from the control unit SE to the release unit LC.

According to FIG. 1, the mechanical contacts K1, K2, K3, KN are assigned to the load-side phase connections/the load side Load and the electronic switches S1, S2, S3 are assigned to the grid-side phase connections/grid side Grid.

The grid-side neutral conductor connection NG is connected to the load-side neutral conductor connection NL via the neutral conductor contact KN. An electronic interrupt unit is not provided in this example in the neutral conductor path in the housing of the circuit breaker. That is to say, the neutral conductor connection between grid-side neutral conductor connection NG and load-side neutral conductor connection NL is free of electronic switches (electronic-switch-free).

Specifically, the mechanical break contact unit MK can be configured in such a manner that prior to the closing of the phase contacts K1, K2, K3, the neutral conductor contact KN is closed. Analogously, following the opening of the phase contacts K1, K2, K3, the neutral conductor contact KN can be opened.

The first electronic switch S1, the second electronic switch S2 and the third electronic switch S3 can be part of an electronic interrupt unit EU, wherein the electronic switches S1, S2, S3 are switchable independently of one another.

The electronic interrupt unit/the electronic switches can have a bidirectional dielectric strength. Specifically, a surge protector is provided for the semiconductor-based switching elements, in order to limit the voltages and thus have protection for the semiconductor-based switching elements.

A control unit SE is provided (as already referenced to some extent), which is connected to the current sensor units SI1, SI2, SI3, the mechanical contacts K1, K2, K3, KN or the mechanical break contact unit MK (as drawn in FIG. 1) and the electronic switches S1, S2, S3.

The current sensor units SI1, SI2, SI3 in each case deter-mine the level of the current of their respective conductor, so that in particular instantaneous values of the cur-rent are known.

When at least one first current threshold value, particularly an instantaneous value of the current, is exceeded in a conductor, avoidance of the current flow of the relevant conductor is initiated by the electronic switch becoming high-resistance.

Being high-resistance can take place for a first time span in particular. After the first time span, the relevant electronic switch can become low-resistance again. The first time span can in particular be less than 20 ms, especially less than 10 ms (especially with reference to a 50 Hz low-voltage AC circuit).

Becoming low-resistance can alternatively or additionally take place in particular at the next zero crossing or prior to or following the zero crossing of the voltage. (All 3 options: at the zero crossing, prior to the zero crossing or following the zero crossing (for example within a milli-second/1 ms)—or in the event of falling below a voltage threshold, particularly 50 V, 25 V or 10 V, in terms of magnitude—are possible.)

The circuit breaker can be configured in such a manner that when a second current threshold value, which may be an ef-fective value in particular, is exceeded in at least one phase conductor (or two phase conductors, particularly in three phase conductors) for at least a first time period, avoidance of a current flow is initiated by opening the contacts. The first time period is less than 100 ms, 10 ms or more specifically 1 ms.

The second current threshold value can advantageously be greater/less than the first current threshold value in terms of magnitude.

A residual current sensor unit ZCT can be provided, e.g. as marked in FIG. 1, for detecting residual currents of the low-voltage AC circuit, as is known e.g. from residual-cur-rent-operated circuit breakers. The residual current sensor unit ZCT is connected to the control unit SE.

The current sensor units SI1, SI2, SI3 are arranged in the example according to FIG. 1 between grid-side connections LG1, LG2, LG3 of the series connection of the electronic switch S1, S2, S3 and the mechanical phase contact K1, K2, K3. Actually between grid-side connections LG1, LG2, LG3 and the electronic switches S1, S2, S3. The current sensor units SI1, SI2, SI3 can also be arranged elsewhere. For example, between electronic switches S1, S2, S3 and mechanical phase contacts K1, K2, K3. The same is true for the residual current sensor unit.

FIG. 2 shows an illustration according to FIG. 1, with the following differences.

On the one hand, a power supply NT, such as for example a power supply unit, is provided for providing power to the circuit breaker SG, particularly the control unit SE. The power supply NT is connected on one side in the example to the phase conductors L1, L2, L3 and to the neutral conductor N. It may also be connected only to a portion of the conductors (at least two) for supplying power. The power supply NT is connected on the other side in the example to the control unit SE for supplying power to the same.

On the other hand, the control unit SE is combined with the electronic switches S1, S2, S3 and the current sensor units SI1, SI2, SI3, as illustrated in FIG. 2.

Furthermore, a voltage sensor unit is provided in each case between each phase conductor and the neutral conductor. Between the first phase conductor L1 and neutral conductor N, a first voltage sensor unit SU1 is provided, between the second phase conductor L2 and neutral conductor N, a second voltage sensor unit SU2 is provided, and between the third phase conductor L3 and neutral conductor N, a third voltage sensor unit SU3 is provided, for determining the level of the voltage between the respective phase conductor and the neutral conductor, particularly that instantaneous voltage values are known. The voltage sensor units SU1, SU2, SU3 are connected to the control unit SE.

When the control unit SE initiates the electronic switches S1, S2, S3 becoming low-resistance, for example:
when becoming low-resistance is initiated by a user or
when becoming low-resistance is initiated by the circuit breaker, especially if there is no overcurrent event (i.e. if the first or second current threshold value is not exceeded), e.g. if an internal checking function (for internal checking) of the circuit breaker initiates becoming low-resistance,
the electronic switches can advantageously become low-resistance successively at the respective zero crossing of the voltage (e.g. in the vicinity of the zero crossing of the voltage, defined by the voltage falling below e.g. 50 V, 25 V or 10 V in terms of magnitude).

When the control unit SE initiates the electronic switches S1, S2, S3 becoming high-resistance, for example:
when becoming high-resistance is initiated by a user or
when becoming high-resistance is initiated by the circuit breaker, especially if there is no overcurrent event (i.e. if the first or second current threshold value is not exceeded), e.g. if an internal checking function (for internal checking) of the circuit breaker initiates becoming high-resistance,
the electronic switches can advantageously become high-resistance successively at the respective zero crossing of the voltage (e.g. in the vicinity of the zero crossing of the voltage, defined by the voltage falling below e.g. 50 V, 25 V or 10 V in terms of magnitude).

To this end, the voltage sensor units SU1, SU2, SU3 are, as mentioned previously, connected to the control unit SE, which is further connected to the current sensor units SI1, SI2, SI3, the mechanical phase contacts K1, K2, K3 (or mechanical break contact unit MK) and the electronic switches (S1, S2, S3). The circuit breaker can further advantageously be configured in such a manner that when at least a first current threshold value (especially the instantaneous value of the current) is exceeded in a conductor, avoidance of a current flow of the relevant conductor is initiated by the relevant electronic switch. At the next or next but one zero crossing of the voltage, the electronic switch becomes low-resistance again in order to enable a current flow.

This can take place several times until a first number of repetitions is exceeded. Then:
a) all electronic switches can become high-resistance, or (/and)
b) the contacts are opened (electrical isolation).

FIG. 3 shows an illustration according to FIG. 2, with the difference that a measuring resistance is provided in each case between a phase conductor and the neutral conductor. To this end, a first measuring resistance R1 (or measuring impedance) is provided between the first phase conductor L1 and the neutral conductor N, a second measuring resistance R2 (or measuring impedance) is provided between the second phase conductor L2 and the neutral conductor N, and a third measuring resistance R3 (or measuring impedance) is provided between the third phase conductor L3 and the neutral conductor N.

Thus, a check of the switching performance of the electronic switches S1, S2, S3 can be carried out by means of the measuring resistances R1, R2, R3 (which may also be realized as measuring impedances, i.e. e.g. as resistance/ca-pacitance or/and inductance combinations), for example by briefly switching on (μs, ms or small second range) the electronic switches with contacts open, wherein a measuring current corresponding (at the respective instantaneous values of the voltage) to the measuring resistance (the measuring impedance) is provided and can be checked. This can take place by briefly switching on an electronic switch in order to generate a measuring current across the respective measuring resistance between phase conductor and neutral conductor. Alternatively or additionally, this can also take place by briefly switching on two electronic switches in order to generate a measuring current across two phase conductors (two measuring resistances).

The (optional) residual current sensor unit ZCT is not provided in this example (but could likewise be provided).

High-resistance means a state in which only a current of insignificant size still flows. In particular, high-resistance means resistance values of greater than 1 kilohm, better greater than 10 kilohms, 100 kilohms, 1 megohm, 10 megohms, 100 megohms, 1 gigohm or greater.

Low-resistance means a state in which the current value indicated on the circuit breaker could flow. In particular, low-resistance means resistance values which are less than 10 ohms, better less than 1 ohm, 100 milliohms, 10 milliohms, 1 milliohm or less.

The electronic switches S1, S2, S3 or the electronic interrupt unit EU can have semiconductor components such as bipolar transistors, field effect transistors (FETs), iso-lated gate bipolar transistors (IGBTs), metal oxide layer field effect transistors (MOSFETs) or other (self-commu-tated) power semiconductors. IGBTs and MOSFETs in particular are particularly well suited for the electronic switches (as semiconductor-based switching elements) owing to low forward resistances, high barrier junction resistances and a good switching performance.

The circuit breaker according to the invention therefore contains electronic and mechanical components. The sensible arrangement of all necessary components for safe operation 13 is one point. Furthermore, a plurality of switching combinations are possible by combining an electronic switch and mechanical contacts.

The circuit breaker in the example has four grid-side and four load-side connections in each case. In the device in the example, there is a 4-pole mechanical break contact system. The contacts are mechanically coupled to one another and can only be opened or closed together. In the phase conductors, there is an electronic switch in series to the mechanical contact. Unlike the mechanical contacts, these are switched on or off independently of one another. Furthermore, a current sensor unit is provided in the phase conductors (not in the neutral conductor N).

A conventional, e.g. three-pole or four-pole protective device today has (essentially) only two switching states: on or off.

According to the invention, further switching states are proposed in the example for a four-pole circuit breaker (for e.g. 3 phase conductors and one neutral conductor), see the following table.

| | | (4-pole) | | | |
|---|---|---|---|---|---|
| | | mechanical | | | |
| | | contacts | Electronic | Electronic | Electronic |
| | Switching | K1, K2, | switch | switch | switch |
| Number | state | K3, KN | S1 | S2 | S3 |
| 1 | Off | Open | High- | High- | High- |
| | | | resistance | resistance | resistance |
| 10 | Test 1 | Open | Low- | High- | High- |
| | | | resistance | resistance | resistance |
| 11 | Test 2 | Open | High- | Low- | High- |
| | | | resistance | resistance | resistance |
| 12 | Test 3 | Open | High- | High- | Low- |
| | | | resistance | resistance | resistance |
| 13 | Test 4 | Open | Low- | Low- | Low- |
| | | | resistance | resistance | resistance |
| 2 | On | Closed | Low- | Low- | Low- |
| | | | resistance | resistance | resistance |
| 3 | Standby | Closed | High- | High- | High- |
| | | | resistance | resistance | resistance |
| 4 | Hybrid 1 | Closed | Low- | High- | High- |
| | | | resistance | resistance | resistance |
| 5 | Hybrid 2 | Closed | High- | Low- | High- |
| | | | resistance | resistance | resistance |
| 6 | Hybrid 3 | Closed | High- | High- | Low- |
| | | | resistance | resistance | resistance |
| 7 | Hybrid 12 | Closed | Low- | Low- | High- |
| | | | resistance | resistance | resistance |
| 8 | Hybrid 13 | Closed | Low- | High- | Low- |
| | | | resistance | resistance | resistance |
| 9 | Hybrid 23 | Closed | High- | Low- | Low- |
| | | | resistance | resistance | resistance |

In addition to the switching states, OFF, ON, known today, there are further states such as Standby, Hybrid 1, 2, 3, and Hybrid 12, 13, 23. Furthermore, test states (Test 1, Test 2, Test 3, optional Test 4) are available for the electronic switches.

Due to the novel hybrid switching states, the circuit breaker can react differently than previously to specific load cases or fault cases. It may therefore be advantageous in a particular fault case to bring only one or even two of the electronic switches contained into the high-resistance (Off) state. Even in the case of the switching on and off of loads, it may be advantageous to carry out a switching sequence in which only one or even two of the electronic switches contained are switched on temporarily.

Switching on may take place for example in that the electronic switches are switched on successively at the zero crossing of the voltage (that is to say not at the same time, but rather at temporally offset times, e.g. at the respective zero crossing of the voltage of the respective phase/the respective phase conductor (which are phase-shifted e.g. by) 120°. Likewise, a switch-off process could proceed analogously.

As a result, it is possible to achieve reduced system perturbations and to reduce the switch-off loading in the switching device (particularly in the electronic switch).

Overcurrent events (exceeding of current threshold value) can be handled per phase/phase conductor. Thus, the electronic switches are also protected from an overload.

Likewise, phases can briefly become disconnected (high-resistance), for example for test purposes.

The number of hybrid states or hybrid states occurring per unit time can be counted and if a limit number is exceeded, all electronic switches can become high-resistance (or (/and) the mechanical contacts can be opened).

In the case of single-phase consumers, it is possible to provide a higher availability (fault only on one phase, disconnect only the one phase, continue to operate the other phases).

The circuit breaker in one variant consequently has at least the following switching states:
(1) all mechanical contacts open, all electronic switches high-resistance,
(2) all mechanical contacts closed, all electronic switches low-resistance,
(3) all mechanical contacts closed, all electronic switches high-resistance,
(4) all mechanical contacts closed, the first electronic switch low-resistance, the second and third electronic switches high-resistance,
(5) all mechanical contacts closed, the second electronic switch low-resistance, the first and third electronic switches high-resistance,
(6) all mechanical contacts closed, the third electronic switch low-resistance, the first and second electronic switches high-resistance.

The circuit breaker in a further variant consequently has at least the following switching states:
(1) all mechanical contacts open, all electronic switches high-resistance,
(2) all mechanical contacts closed, all electronic switches low-resistance,
(3) all mechanical contacts closed, all electronic switches high-resistance,
(7) all mechanical contacts closed, the first and second electronic switches low-resistance, the third electronic switch high-resistance,
(8) all mechanical contacts closed, the first and third electronic switches low-resistance, the second electronic switch high-resistance,
(9) all mechanical contacts closed, the second and third electronic switches low-resistance, the first electronic switch high-resistance.

The circuit breaker in a further variant consequently has the following switching states:
(1) all mechanical contacts open, all electronic switches high-resistance,
(2) all mechanical contacts closed, all electronic switches low-resistance,
(3) all mechanical contacts closed, all electronic switches high-resistance,
(4) all mechanical contacts closed, the first electronic switch low-resistance, the second and third electronic switches high-resistance,
(5) all mechanical contacts closed, the second electronic switch low-resistance, the first and third electronic switches high-resistance,
(6) all mechanical contacts closed, the third electronic switch low-resistance, the first and second electronic switches high-resistance,
(7) all mechanical contacts closed, the first and second electronic switches low-resistance, the third electronic switch high-resistance,
(8) all mechanical contacts closed, the first and third electronic switches low-resistance, the second electronic switch high-resistance,
(9) all mechanical contacts closed, the second and third electronic switches low-resistance, the first electronic switch high-resistance.

The circuit breaker in one variant consequently furthermore has at least a portion (or all) of the following switching states:
(10) all mechanical contacts open, the first electronic switch low-resistance, the second electronic switch and the third electronic switch high-resistance,
(11) all mechanical contacts open, the second electronic switch low-resistance, the first electronic switch and the third electronic switch high-resistance,
(12) all mechanical contacts open, the third electronic switch low-resistance, the first electronic switch and the second electronic switch high-resistance,
(13) all mechanical phase contacts open, the first, second and third electronic switches low-resistance.

The circuit breaker in one variant can further consequently, as an example, have at least one (or all) of the following switching states:
(14) all mechanical contacts open, the first electronic switch and the second electronic switch low-resistance, the third electronic switch high-resistance,
(15) all mechanical contacts open, the second electronic switch and the third electronic switch low-resistance, the first electronic switch high-resistance,
(16) all mechanical contacts open, the first electronic switch and the third electronic switch low-resistance, the second electronic switch high-resistance.

In general, the circuit breaker is for example characterized by at least the following novel switching state:
all mechanical contacts closed, a portion of the electronic switches low-resistance, the other portion of the electronic switches high-resistance.

Mechanical contact or mechanical break contact unit MK is understood in particular to mean a (standards-compliant) isolating function that is realized by the break contact unit MK. Isolating function is understood to mean the points:
minimum air gap in accordance with standard (minimum spacing of the contacts),
contact position indicator of the contacts of the mechanical break contact unit,
actuation/interruption of the contacts of the mechanical break contact unit (by the control unit) always possible (not possible to (permanently) lock the contacts into the closed state by means of the handle).

With regard to the minimum air gap between the contacts of the break contact unit, this minimum air gap is substan-tially voltage-dependent. Further parameters are the degree of soiling, the type of the field (homogeneous, inhomogeneous), and the air pressure or the height above mean sea level.

There are corresponding regulations or standards for these minimum air gaps or creepage distances. These regulations specify the minimum air gap, for example in air for a surge withstand capability, for an inhomogeneous and a homogeneous (ideal) electric field, depending on the degree of soiling. The surge withstand capability is the strength when a corresponding surge voltage is applied. Only if this minimum length (minimum gap) is present does the break contact unit or circuit breaker have an isolating function (disconnector feature).

In the meaning of the invention, the standard series DIN EN 60947 or IEC 60947 are relevant here for the disconnector function and its properties, which standard series are re-ferred to here by reference.

The break contact unit is advantageously characterized by a minimum air gap of the open break contacts in the OFF position (open position, open contacts) depending on the rated surge withstand capability and the degree of soiling. The minimum air gap is between (at a minimum) 0.01 mm and 14 mm in particular. In particular, the minimum air gap advantageously is between 0.01 mm at 0.33 kV and 14 mm at 12 kV, particularly for degree of contamination 1 and in particular for inhomogeneous fields.

Advantageously, the minimum air gap can have the following values:

### E DIN EN 60947-1 (VDE 0660-100): 2018-06

TABLE 13
Minimum air gaps

| | Minimum air gaps | | | | | | | |
|---|---|---|---|---|---|---|---|---|
| | mm | | | | | | | |
| | | | | | Case B | | | |
| Rated surge | Case A | | | | Homogeneous field, ideal | | | |
| withstand | Inhomogeneous field | | | | conditions | | | |
| capability | (see 3.7.63) | | | | (see 3.7.62) | | | |
| Uimp | Degree of soiling | | | | Degree of soiling | | | |
| kV | 1 | 2 | 3 | 4 | 1 | 2 | 3 | 4 |
| 0.33 | 0.01 | 0.2 | 0.8 | 1.6 | 0.01 | 0.2 | 0.8 | 1.6 |
| 0.5 | 0.04 | | | | 0.04 | | | |
| 0.8 | 0.1 | | | | 0.1 | | | |
| 1.5 | 0.5 | 0.5 | | | 0.3 | 0.3 | | |
| 2.5 | 1.5 | 1.5 | 1.5 | | 0.6 | 0.6 | | |
| 4.0 | 3 | 3 | 3 | 3 | 1.2 | 1.2 | 1.2 | |
| 6.0 | 5.5 | 5.5 | 5.5 | 5.5 | 2 | 2 | 2 | 2 |
| 8.0 | 8 | 8 | 8 | 8 | 3 | 3 | 3 | 3 |
| 12 | 14 | 14 | 14 | 14 | 4.5 | 4.5 | 4.5 | 4.5 |

NOTE
The smallest air gaps specified are based on the 1.2/50 μs surge voltage at an air pressure of 80 kPa, which corresponds to the air pressure at 2,000 m above MSL.

The degrees of soiling and field types correspond to those defined in the standards. As a result, it is advantageously possible to achieve a standards-compliant circuit breaker that is dimensioned in accordance with the rated surge withstand capability.

Mechanical break contact unit is in particular not understood to mean a relay contact. Although the invention was illustrated and described in detail by the exemplary embodiment, the invention is not lim-ited by the disclosed examples and other variations can be deduced from this by a person skilled in the art without departing from the protective scope of the invention.

1-18. (canceled)

19. A circuit breaker for protecting an electrical three-phase low-voltage AC circuit with neutral conductors, the circuit breaker comprising:
a housing having a first, second and third grid-side phase connection and a first, second and third load-side phase connection for a first, second and third phase conductor of the low-voltage AC circuit, said housing further having a grid-side neutral conductor connection and a load-side neutral conductor connection for a neutral conductor of the low-voltage AC circuit;
a first series connection of a first mechanical phase contact and a first electronic switch, said first series connection electrically connecting said first grid-side phase connection to said first load-side phase connection;
a second series connection of a second mechanical phase contact and a second electronic switch, said second series connection electrically connecting said second grid-side phase connection to said second load-side phase connection;
a third series connection of a third mechanical phase contact and a third electronic switch, said third series connection electrically connecting said third grid-side phase connection to said third load-side phase connection;
a mechanical neutral conductor contact connecting said grid-side neutral conductor connection to said load-side neutral conductor connection, wherein said first, second and third mechanical phase contacts and said mechanical neutral conductor contact being switched to open together for avoiding a current flow or being switched to close together for allowing the current flow;
said first, second and third electronic switches having semiconductor-based switching elements, said first, second and third electronic switches being switched by means of said semiconductor-based switching elements into a high-resistance state of said semiconductor-based switching elements for avoiding the current flow or a low-resistance state of said semiconductor-based switching elements for allowing the current flow; and
the circuit breaker is configured such that said first, second and third electronic switches are switched independently of one another to the high-resistance state or the low-resistance state.

20. The circuit breaker according to claim 19, further comprising first, second and third current sensors, said first current sensor disposed in said first series connection, said second current sensor disposed in said second series connection and said third current sensor unit disposed in said third series connection, said current sensors respectively determining a level of the current of the first, second and third phase conductors.

21. The circuit breaker according to claim 19, wherein said first mechanical phase contact, said second mechanical phase contact, said third mechanical phase contact and said mechanical neutral conductor contact form a mechanical break contact unit which opens or closes said mechanical phase contacts together.

22. The circuit breaker according to claim 21, wherein said mechanical break contact unit has a handle that is accessible on the circuit breaker for manual opening or closing of said mechanical phase contacts.

23. The circuit breaker according to claim 19, wherein said first electronic switch, said second electronic switch and said third electronic switch define an electronic interrupt unit, wherein said electronic switches are switchable independently of one another.

24. The circuit breaker according to claim 19, wherein said mechanical phase contacts are assigned to said load-side phase connections and said electronic switches are assigned to said grid-side phase connections.

25. The circuit breaker according to claim 20, further comprising a controller connected to said current sensors, said mechanical phase contacts and said electronic switches, wherein the circuit breaker is configured such that when at least one first current threshold value is exceeded in a phase conductor, avoidance of the current flow of the phase conductor is initiated, for a first time span, by a respective one of said electronic switches.

26. The circuit breaker according to claim 25, wherein the first time span is less than 20 ms.

27. The circuit breaker according to claim 25, wherein the circuit breaker is configured such that when at least one second current threshold value is exceeded in at least one phase conductor, avoidance of the current flow is initiated by opening said mechanical phase contacts.

28. The circuit breaker according to claim 25, further comprising voltage sensors, one of said voltage sensors is connected in each case between one of the phase conductors and the neutral conductor for determining a level of a voltage between a respective one of the phase conductors and the neutral conductor, wherein said voltage sensors are connected to said controller.

29. The circuit breaker according to claim 28, wherein when said controller initiates said electronic switches to obtain the low-resistance state, said electronic switches obtain the low-resistance state successively at a respective zero crossing of the voltage.

30. The circuit breaker according to claim 28, wherein when said control unit initiates said electronic switches to obtain the high-resistance state, said electronic switches obtain the high-resistance state successively at a respective zero crossing of the voltage.

31. The circuit breaker according to claim 28, wherein:
said controller being connected to said current sensor units, said voltage sensors, said mechanical phase contacts and said electronic switches;
the circuit breaker is configured such that when the at least one first current threshold value is exceeded in one of the conductors, avoidance of the current flow of the one conductor is initiated by a respective one of said electronic switches; and
at a next or next but one zero crossing of the voltage, said respective electronic switch obtains the low-resistance state again in order to enable the current flow.

32. The circuit breaker according to claim 19, wherein the circuit breaker has at least the following switching states:
all of said mechanical phase contacts are open, and all of said electronic switches have the high-resistance state;
all of said mechanical phase contacts are closed, and all of said electronic switches have the low-resistance state;
all of said mechanical phase contacts are closed, and all of said electronic switches have the high-resistance state;
all of said mechanical phase contacts are closed, said first electronic switch has the low-resistance state, and said second and said third electronic switches have the high-resistance state;
all of said mechanical phase contacts are closed, said second electronic switch has the low-resistance state, and said first and third electronic switches have the high-resistance state;
all of said mechanical phase contacts are closed, said third electronic switch has the low-resistance state, and said first and second electronic switches have the high-resistance state; and
all of said mechanical phase contacts are open, at least one of said electronic switches has the low-resistance state.

33. The circuit breaker according to claim 19, wherein the circuit breaker has at least the following switching states:
all of said mechanical phase contacts are open, and all of said electronic switches have the high-resistance state;
all of said mechanical phase contacts are closed, and all of said electronic switches have the low-resistance state;
all of said mechanical phase contacts are closed, and all of said electronic switches have the high-resistance state;
all of said mechanical phase contacts are closed, said first and second electronic switches have the low-resistance state, and said third electronic switch has the high-resistance state;
all of said mechanical contacts are closed, said first and third electronic switches have the low-resistance state, and said second electronic switch has the high-resistance state; and
all of said mechanical phase contacts are closed, said second and third electronic switches have the low-resistance state, and said first electronic switch has the high-resistance state.

34. The circuit breaker according to claim 19, wherein the circuit breaker has the following switching states:
all of said mechanical phase contacts are open, and all of said electronic switches have the high-resistance state;
all of said mechanical phase contacts are closed, and all of said electronic switches have the low-resistance state;
all of said mechanical phase contacts are closed, and all of said electronic switches have the high-resistance state;
all of said mechanical phase contacts are closed, and said first electronic switch has the low-resistance state, and the second and third electronic switches have the high-resistance state;
all of said mechanical phase contacts are closed, said second electronic switch has the low-resistance state, and said first and third electronic switches have the high-resistance state;
all of said mechanical phase contacts are closed, said third electronic switch has the low-resistance state, and said first and second electronic switches have the high-resistance state;
all of said mechanical phase contacts are closed, said first and second electronic switches have the low-resistance state, and said third electronic switch has the high-resistance state;
all of said mechanical phase contacts are closed, said first and third electronic switches have the low-resistance state, and said second electronic switch has the high-resistance state; and
all of said mechanical phase contacts are closed, said second and third electronic switches have the low-resistance state, and said first electronic switch has the high-resistance state.

35. The circuit breaker according to claim 21, wherein prior to the closing of said mechanical phase contacts, said neutral conductor contact is closed or, following an opening of said mechanical phase contacts, said neutral conductor contact is opened.

36. The circuit breaker according to claim 25, wherein the circuit breaker is configured such that when at least one second current threshold value is exceeded in at least one phase conductor, for at least a first time period, avoidance of the current flow is initiated by opening said mechanical phase contacts.

37. A method for a circuit breaker for protecting an electrical three-phase low-voltage AC circuit with neutral conductors, which comprises:
providing series connections of a mechanical phase contact and an electronic switch, wherein in each case one of the series connections electrically connects a grid-side phase connection to a load-side phase connection;
connecting a grid-side neutral conductor connection to a load-side neutral conductor connection via a mechanical neutral conductor contact;
opening the mechanical phase contacts together for avoiding a current flow or closing the mechanical phase contacts together for allowing the current flow;
switching the electronic switches by means of semiconductor-based switching elements into a high-resistance state of the semiconductor-based switching elements for avoiding the current flow or a low-resistance state of the semiconductor-based switching elements for allowing the current flow; and
switching the semiconductor-based electronic switches into the high-resistance state or the low-resistance state independently of one another, in order to avoid or to enable a phase-conductor-dependent current flow.

38. The method according to claim 37, which further comprises determining a level of the current of a respective one of the series connections and when at least one first current threshold value is exceeded in the respective series connection, avoidance of the current flow of the respective series connection is initiated by the electronic switch.
